(19) United States
(12) Patent Application Publication
(10) Pub. No.: US 2018/0034883 A1
(43) Pub. Date: Feb. 1, 2018

(54) OPERATING METHOD OF CLIENT FOR STREAMING SERVICE

(71) Applicant: AIRBROAD INC., Seoul (KR)

(72) Inventor: Jae Kyeong KIM, Seoul (KR)

(21) Appl. No.: 15/274,009

(22) Filed: Sep. 23, 2016

(30) Foreign Application Priority Data
Jul. 29, 2016 (KR) 10-2016-0096803

(51) Int. Cl. H04L 29/06

(52) U.S. Cl. CPC H04L 65/607; H04L 65/608; H04L 67/02

(57) ABSTRACT

An operating method of a client for a streaming service, the method including determining a request byte range based on header information of a streaming media, receiving a media chunk of the request bye range among data of the streaming media, and playing back the received media chunk.

### CROSS-REFERENCE TO RELATED APPLICATION(S)

This application claims the priority benefit of Korean Patent Application No. 10-2016-0096803 filed on Jul. 29, 2016, in the Korean Intellectual Property Office, the disclosure of which is incorporated herein by reference for all purposes.

### FIELD OF THE INVENTION

One or more example embodiments relate to an operating method of a client for a streaming service.

### BACKGROUND

Many streaming techniques according to the related art, for example, Korean Patent Publication No. 10-2014-0054138 published on May 8, 2014, and Korean Patent Publication No. 10-2012-0117384 published on Oct. 24, 2012, have employed a streaming exclusive protocol, such as a real time streaming protocol (RTSP). However, the recent streaming techniques are designed to efficiently operate on a widely distributed HyperText Transfer Protocol (HTTP) network, such as the Internet. For example, an adaptive bitrate streaming technique is an HTTP-based streaming technique that may transmit contents of quality consumable at a bandwidth based on a network state or a transmission rate, etc.

The adaptive bitrate streaming technique divides and transmits a file based on a time unit. For example, the adaptive bitrate streaming technique may provide a streaming service using a chunk that stores content with a time length of two to ten seconds. Here, each of chunks to be transmitted is required to start as a predetermined key frame, such as an I-frame. To satisfy the condition, the adaptive bitrate streaming technique essentially requires a process of transcoding an image file to a streaming file. During the transcoding process, the quality of an image file maybe degraded. Further, additional time and computing power for transcoding may be additionally used.

Also, the adaptive bitrate streaming technique is to use a manifest file. The manifest file refers to a file that stores information about each of chunks of a streaming file. The manifest file is created when the image file is transcoded to the streaming file. According to the adaptive bitrate streaming technique, a client is to refer to the manifest file to utilize a streaming service.

### SUMMARY

One or more example embodiments provide a HyperText Transfer Protocol (HTTP) based streaming technique using an image file format as is instead of using a streaming file format. One or more example embodiments also provide a technique that may divide and thereby transmit an image file based on a capacity unit. For example, one or more example embodiments may provide a streaming service for transmitting a portion of an image file based on a byte address unit without actually dividing the image file. Here, a process of transcoding the image file to a streaming file may be omitted.

One or more example embodiments may prevent a degradation in quality occurring during transcoding and may reduce a server load by omitting a process of transcoding an image file to a streaming file. Also, one or more example embodiments may provide a further fast streaming service since a time for transcoding an image file to a streaming file is not used once the image file is uploaded to a server. Also, one or more example embodiments may not require a manifest file that stores chunk information of a streaming file since the streaming file is not created separately.

According to an aspect, there is provided an operating method of a client for a streaming service, the method including receiving a header of a file corresponding to a file uniform resource locator (URL) from a streaming server; determining a first byte range based on the header; transmitting a first request packet that includes the file URL and the first byte range to the streaming server; receiving a first media chunk of the first byte range among media data of the file corresponding to the file URL; and playing back the first media chunk.

The client operating method may further include receiving a seek request; determining a second byte range based on the header and the seek request; transmitting a second request packet that includes the file URL and the second byte range to the streaming server; receiving a second media chunk of the second byte range among the media data of the file corresponding to the file URL; and playing back the second media chunk.

The determining of the second byte range may include acquiring one of a random access point (RAP) of a point corresponding to the seek request and a previous RAP of a point before the point, based on the header; and setting one of the RAP and the previous RAP as a start point of the second byte range.

The client operating method may further include receiving a resolution change request; receiving a header of a second file having a resolution corresponding to the resolute change request from the streaming server; determining a second byte range based on the header of the second file and a current playback point; transmitting a second request packet that includes a file URL of the second file and the second byte range to the streaming server; receiving a second media chunk of the second byte range among media data of the second file; and playing back the second media chunk.

The determining of the second byte range may include acquiring a subsequent RAP of a point after the current playback point, based on the header of the second file; and setting the subsequent RAP as a start point of the second byte range.

The playing back of the first media chunk may include creating a first header for the first media chunk based on the header; and playing back a first chunk media file that includes the first header and the first media chunk using a first thread.

The client operating method may include determining a second byte range based on the first byte range; transmitting a second request packet that includes the file URL and the second byte range to the streaming server; receiving a second media chunk of the second byte range among the media data of the file corresponding to the file URL; and playing back the second media chunk.

The playing back of the second media chunk may include creating a second header for the second media chunk based on the header; and playing back a second chunk media file that includes the second header and the second media chunk using a second thread.

The playing back of the second chunk media file may include detecting whether a playback start point of the second media chunk is reached; switching a first thread used to decode the first media chunk to the second thread in response to reaching the playback start point of the second media chunk; and decoding the second media chunk using the second thread.

The playing back of the second media chunk may include setting a 2'-nd media chunk that includes at least a portion of the first media chunk and at least a portion of the second media chunk; creating a 2'-nd header for the 2'-nd media chunk based on the header; and playing back a 2'-nd chunk media file that includes the 2'-nd header and the 2'-nd media chunk using a second thread.

The setting of the 2'-nd media chunk may include including a portion of the first media chunk in the 2'-nd media chunk based on a previous or subsequent frame range referred to by a frame encoded using an open GOP (group of pictures).

The client operating method may further include receiving a plurality of file URLs corresponding to a plurality of resolutions of the same content from the streaming server.

According to another aspect, there is provided a client device for a streaming device, including a memory configured to store a header and a file URL of a file of a first resolution; a processor configured to determine a first byte range based on the header; and a communicator configured to transmit a first request packet that includes the file URL and the first byte range to the streaming server, and to receive a first media chunk of the first byte range among media data of the file of the first resolution.

In response to a seek request, the processor may be further configured to acquire one of a RAP of a point corresponding to the seek request and a previous RAP of a point before the point, and to determine a second byte range that uses one of the RAP and the previous RAP as a start point, and the communicator may be further configured to transmit a second request packet that includes the file URL and the second byte range to the streaming server, and to receive a second media chunk of the second byte range among the media data of the file of the first resolution.

The memory may be further configured to further store a header and a file URL of a file of a second resolution. In response to a resolution change request, the processor may be further configured to acquire a subsequent RAP of a point after a current playback point based on the header of the file of the second resolution, and to determine a second byte range that uses the subsequent RAP as a start point, and the communicator may be further configured to transmit a second request packet that includes the file URL of the file of the second resolution and the second byte range to the streaming server, and to receive a second media chunk of the second byte range among the media data of the file of the second resolution.

The processor may be further configured to determine a second byte range based on the first byte range, and the communicator may be further configured to transmit a second request packet that includes the file URL and the second byte range to the streaming server, and to receive a second media chunk of the second byte range among the media data of the file of the first resolution.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates an example of describing an operating method of a client according to an example embodiment;

FIG. 2 illustrates an example of playing back media chunks using a plurality of threads according to an example embodiment;

FIG. 3 illustrates an example of describing a transmission and playback scenario of media chunks according to an example embodiment;

FIG. 4 illustrates another example of playing back media chunks using a plurality of threads according to an example embodiment;

FIG. 5 illustrates another example of describing a transmission and playback scenario of media chunks according to an example embodiment;

FIG. 6 illustrates an example of describing a seek request according to an example embodiment;

FIG. 7 illustrates an example of describing a resolution change operation according to an example embodiment;

FIG. 8 illustrates an example of describing an operation of acquiring header information according to an example embodiment; and

FIG. 9 illustrates an example of describing an adaptive streaming service according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure. The example embodiments may be applicable to a server or a client for a streaming service.

Here, the client refers to a computing device that receives the streaming service, and may include, for example, a personal computer (PC), a laptop computer, a tablet computer, a personal digital assistant (PDA), a smartphone, etc. A client application, for example, a web-based MP4 player, etc., communicating with the server using a HyperText Markup Language 5 (HTML5) standard, may be installed on the client. The server refers to a computing device that receives the streaming service, and may include, for example, a web server. The server may be configured as a PC, a laptop computer, a tablet computer, a PDA, a smartphone, etc., as well as a server exclusive computing device.

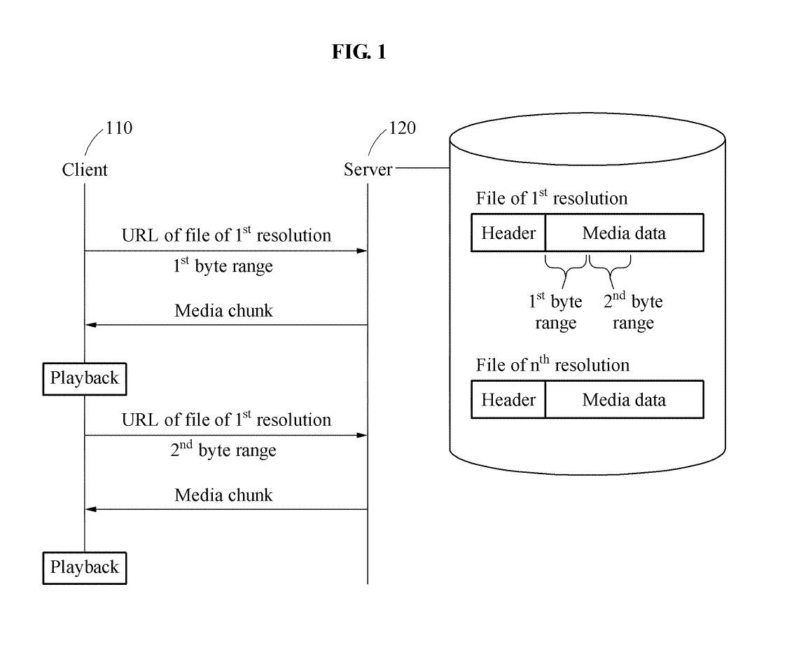

FIG. 1 illustrates an example of describing an operating method of a client according to an example embodiment. Referring to FIG. 1, a client 110 requests a chunk of a media file stored in a server 120 using a byte range. For example, the client 110 may employ a HyperText Transfer Protocol (HTTP)/1.4 standard that allows a range header request.

The server 120 may store files of a plurality of resolutions. Each of the files of the plurality of resolutions may include a header and media data, and may be connected using a different uniform resource locator (URL). Here, the URL refers to information used to uniquely instruct a resource on a computer network. For example, the URL may be information used to uniquely instruct an image file that is a target of a streaming service.

The client 110 may acquire a file list that includes URLs of the files of the plurality of resolutions stored in the server 120. For example, the client 110 may acquire the file list from src attribute of a webpage of the server 120 connected through a web browser and the like.

The file list may include a URL of a file of a first resolution, a URL of a file of a second resolution different from the first resolution, and the like. Depending on cases, the file list may include URLs and resolutions of all of files corresponding to the same content for a consistent data structure. For example, the file list may include a URL of a first file, a resolution of the first file, and a URL and a resolution of each of at least one file that stores content of a resolution different from the resolution of the first file.

Each of files may include a resolution in a file name. For example, once uploading of ‘musicvideo.mp4’ that is a source image file is completed, the server 120 may encode ‘musicvideo.mp4’ at a new resolution. Here, the server 120 may assign the new resolution to a file name of the source image file and may determine the file name of the new resolution.

The client 110 may acquire a header of a file of a first resolution from the server 120. In general, the header of the first resolution is located at a start portion of the file of the first resolution. In this case, the client 110 may acquire the header of the file of the first resolution by requesting the server 120 for a byte range corresponding to the start portion of the file of the first resolution.

Although not illustrated, the header of the file of the first resolution may be located at an end portion or an intermediate portion of the file of the first resolution. In this case, the client 110 may acquire offset at which the header of the file of the first resolution is located by requesting the server 120 for the byte range corresponding to the start portion of the file of the first resolution. The client 110 may acquire the header of the file of the first resolution by requesting the server 120 for a byte range corresponding to a portion subsequent to the offset.

The client 110 transmits, to the server 120, a first request packet that includes a URL of the file of the first resolution and a first byte range. The client 110 may request the server 120 for a media chunk corresponding to a portion, for example, the first byte range, of media data of the file of the first resolution by transmitting the first request packet to the server 120. The client 110 may receive, from the server 120, and play back a media chunk corresponding to the first byte range among the media data of the file of the first resolution. Example embodiments may provide a streaming technique of dividing and thereby transmitting a media file based on a capacity unit.

The client 110 may determine the first byte range based on the header of the file of the first resolution. For example, to play back the file of the first resolution from the start, the client 110 may acquire offset of a first random access point (RAP) from the header of the file of the first resolution. A RAP denotes a point directly accessible within an encoded media stream. Since the RAP does not refer to a previous or subsequent frame, the client 110 may decode the RAP alone without a need to decode the previous or subsequent frame of the RAP. The client 110 may set a start point of the first byte range as the offset of the first RAP.

A size of a byte range requested to the server 120 may be predetermined or set by the client 120. For example, the size of the byte range may be determined to be different for each resolution, or may be set by the client 110 based on a streaming environment, etc. According to the aforementioned scheme, the client 110 may set a start point and a size of the byte range. Depending on cases, the client 110 may set an end point instead of setting the size of the byte range.

The client 110 may transmit, to the server 120, a second request packet that includes the URL of the file of the first resolution and a second byte range while playing back a media chunk corresponding to the first byte range. The second byte range may be a bye range immediately subsequent to the first byte range requested using the first request packet within the file of the first resolution. The client 110 receives, from the server 120, and plays back a media chunk corresponding to the second byte range among media data of the file of the first resolution.

The client 110 may check a buffer residual value. For example, the client 110 may determine whether a buffer residual value is less than or equal to a threshold. The threshold may be a byte unit or a time unit. If the threshold is the time unit, a time unit threshold may be changed to a byte unit threshold based on a resolution of content being played back. If the buffer residual value is less than or equal to the threshold, the client 110 may transmit a second request packet for requesting a subsequent byte range of the first byte range to the server 120.

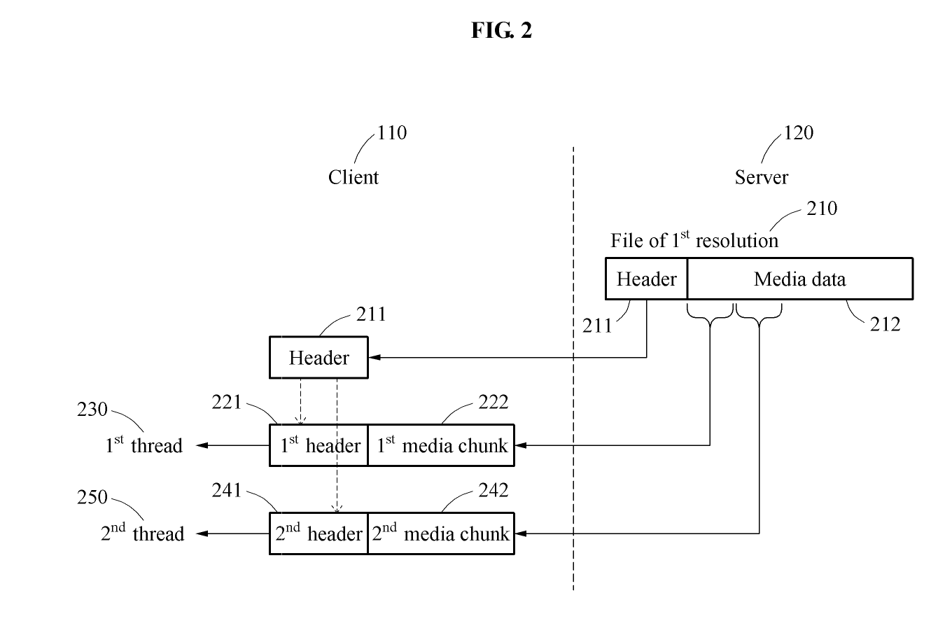

FIG. 2 illustrates an example of playing back media chunks using a plurality of threads according to an example embodiment. Referring to FIG. 2, the client 110 may receive and store a header 211 of a file (210) of a first resolution (hereinafter, a first resolution file) from the server 120. As described above with reference to FIG. 1, the client 110 may request at least a portion of media data 212 of the first resolution file 210 as a byte range.

The client 110 may create a first header 221 by receiving a first media chunk 222 corresponding to a first byte range, and by processing the header 211 to be suitable for the first media chunk 222. For example, the header 211 may include RAP information, key frame information, per frame time interval information, a video frame offset, an audio frame offset, a bye size of a frame, codec information, and the like. The client 110 may extract a portion of information included in the header 211, or may create the first header 221 by correcting offset and the like to be suitable for the first media chunk 222.

The first header 221 and the first media chunk 222 may be recognized as an independent first chunk media file. The client 110 may play back the first chunk media file using a first thread 230. The first thread 230 may be a decoding instance.

The client 110 may create a second header 241 by receiving a second media chunk 242 corresponding to a second byte range, and by processing the header 211 to be suitable for the second media chunk 242. The second header 241 and the second media chunk 242 may be recognized as an independent second chunk media file. The client 110 may play back the second chunk media file using a second thread 250. The second thread 250 may be a decoding instance.

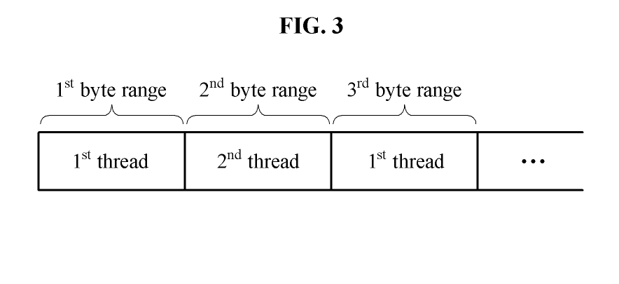

FIG. 3 illustrates an example of describing a transmission and playback scenario of media chunks according to an example embodiment. Referring to FIG. 3, the client 110 may play back media chunks of bye ranges consecutively requested, by alternately using the first thread and the second thread. Each of the media chunks may start with a RAP.

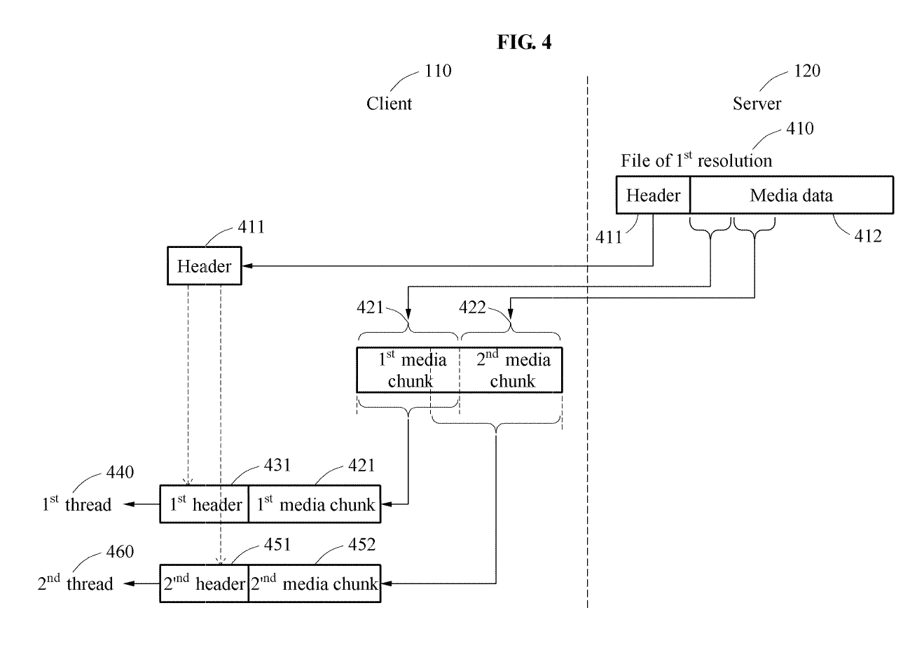

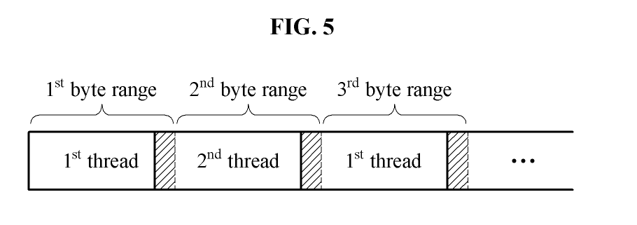

Example embodiments of creating and playing back a chunk media file based on a byte-requested (or byte range-based) media chunk unit are described with reference to FIGS. 2 and 3. Hereinafter, example embodiments in which a byte-requested media chunk and a media chunk included in a chunk media file do not match will be described with reference to FIGS. 4 and 5.

FIG. 4 illustrates another example of playing back media chunks using a plurality of threads according to an example embodiment. Referring to FIG. 4, the client 110 may receive and store a header 411 of a first resolution file 410 from the server 120. The client 110 may request at least a portion of media data 412 of the first resolution file 410 as a bye range.

The client 110 may create a first header 431 by receiving a first media chunk 421 corresponding to a first byte range, and by processing the header 411 to be suitable for the first media chunk 421. The first header 431 and the first media chunk 421 may be recognized as an independent first chunk media file. The client 110 may play back the first chunk media file using a first thread 440.

The client 110 may receive a second media chunk 422 corresponding to a second byte range. Here, the client 110 may create a 2'-nd chunk media file using a 2'-nd media chunk 452 that includes an end portion of the first media chunk 421 and the second media chunk 422. The client 110 may create a 2'-nd header 451 by processing the header 411 to be suitable for the 2'-nd media chunk 452. The 2'-nd header 451 and the 2'-nd media chunk 452 may be recognized as an independent 2'-nd chunk media file. The client 110 may play back the 2'-nd chunk media file using a second thread 460.

In this manner, the client 110 may create chunk media files by overlapping media chunks of byte ranges consecutively requested, by a preset size or time. In this case, the client 110 may support a streaming service about a media stream that is encoded using an open GOP (group of pictures) scheme. For example, an overlapping size or time between adjacent chunk media files may be set to sufficiently include previous or subsequent frames referred to based on open GOP when decoding frames around a point at which a chunk media file is switched to a subsequent chunk media file or a point at which a chunk media file starts. For example, if a byte-requested media chunk includes 24 frames per second, that is, has a size corresponding to about 3 seconds, an overlapping area may be set as a size corresponding to about 0.3 seconds.

FIG. 5 illustrates another example of describing a transmission and playback scenario of media chunks according to an example embodiment. Referring to FIG. 5, the client 110 may play back media chunks of byte ranges consecutively requested, by alternately using the first thread and the second thread.

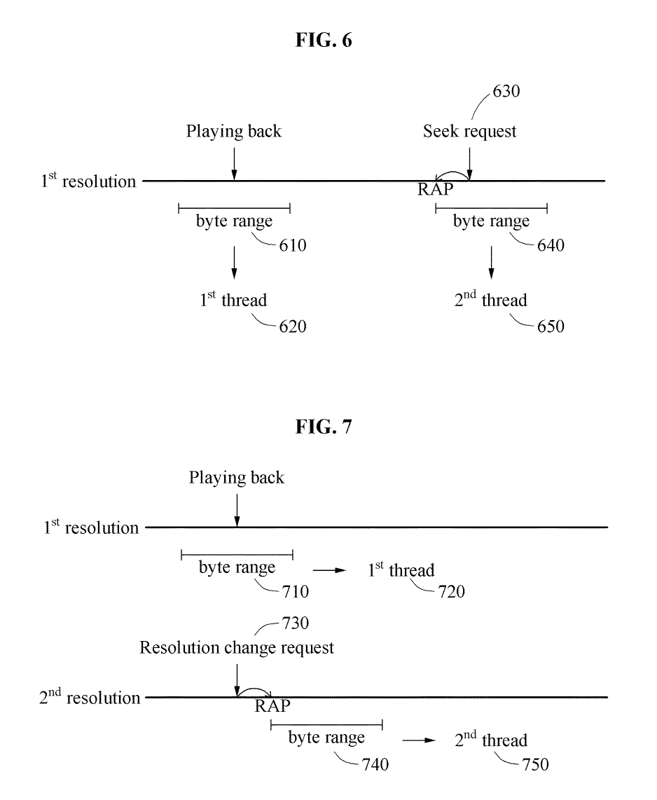

FIG. 6 illustrates an example of describing a seek request according to an example embodiment. Referring to FIG. 6, the client 110 may receive a seek request 630 while a bye range 610 is being played back using a first thread 620. For example, the client 110 may receive a seek input through a predetermined interface. The seek input may include a seek time.

The client 110 may detect a RAP corresponding to the seek time based on a header of a first file. For example, the client 110 may detect a closest RAP identical to a frame of the seek time or ahead of the frame of the seek time.

The client 110 may perform a seek operation by requesting and receiving a bye range 640 that uses the detected RAP as a start point and then by switching the playing back first thread 620 to a second thread 650. Here, the second thread 650 may be played back from a point corresponding to the seek request 630 instead of being played back from the start point of the bye range 640.

FIG. 7 illustrates an example of describing a resolution change operation according to an example embodiment. Referring to FIG. 7, while a bye range 710 is being played back using a first thread 720, the client 110 may receive a resolution change request 730.

For example, the client 110 may provide a resolution of content currently being played back and/or a changeable resolution to a user through a predetermined interface. The client 110 may receive a resolution change input through the interface.

Depending on cases, the client 110 may automatically determine whether to change a resolution. For example, the client 110 may automatically determine whether to change a resolution based on a communication state, whether of buffering, communication cost, and the like.

Hereinafter, example embodiments of switching a first resolution to a second resolution will be described.

The client 110 may receive a header of a second file from the server 120. An operation of receiving the header of the second file is identical to an operation of receiving the header of the first file. Thus, a further description will be omitted.

The client 110 may detect a RAP corresponding to a current playback time based on the header of the second file. For example, the client 110 may detect a closest RAP to a frame after a preset period of time, for example, 1 second is elapsed from a current playback time.

The client 110 may perform a resolution change operation by requesting and receiving a byte range 740 that uses the detected RAP as a start point and then by switching the first thread 720 used to play back the bye range 710 to a second thread 750.

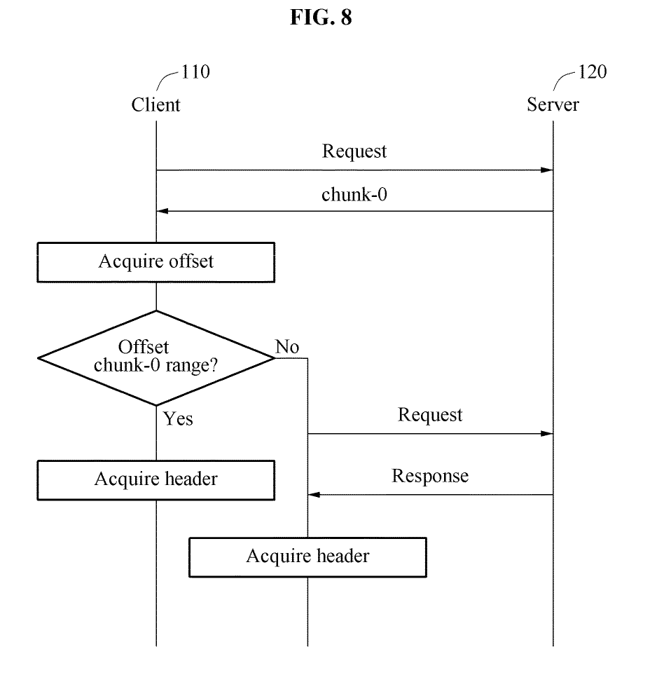

FIG. 8 illustrates an example of describing an operation of acquiring header information according to an example embodiment. A client according to an example may acquire a header of a first file to play back through a streaming service. Content stored in the first file may include a plurality of frames. The plurality of frames may be classified into a frame that fully includes screen information and a frame that refers to another frame. The frame that fully includes screen information may be referred to as a RAP. The frame that refers to another frame does not fully include screen information of a corresponding frame and thus, may have a relatively small capacity compared to the RAP.

The header of the first file may include information about RAPs among a plurality of frames that constitutes the content stored in the first file. For example, the header may include an index, a byte address, a timestamp of each of the RAPs, etc.

For example, the first file may store the header. For example, if the first file is in an MP4 file format, the first file may store the header. In this case, the client may acquire the header by receiving data of a range in which the header is stored from a server.

In detail, referring to FIG. 8, the client 110 may transmit a request packet for requesting an initial chunk (chunk-0) of the first file to the server 120. The client 110 may receive a response packet that includes the initial chunk of the first file from the server 120. The client 110 may extract offset of the header from the initial chunk of the first file.

The client 110 may determine whether the offset is included within the range of the initial chunk, and may determine whether data of the offset is included in the initial chunk. If the offset is included in the range of the initial chunk, the client 110 may acquire the header from the received initial chunk.

On the contrary, if the offset is not included in the range of the initial chunk, the client 110 may transmit a request packet for requesting data subsequent to the offset to the server 120. The client 110 may receive a response packet that includes the data subsequent to the offset, and may extract the header from the response packet.

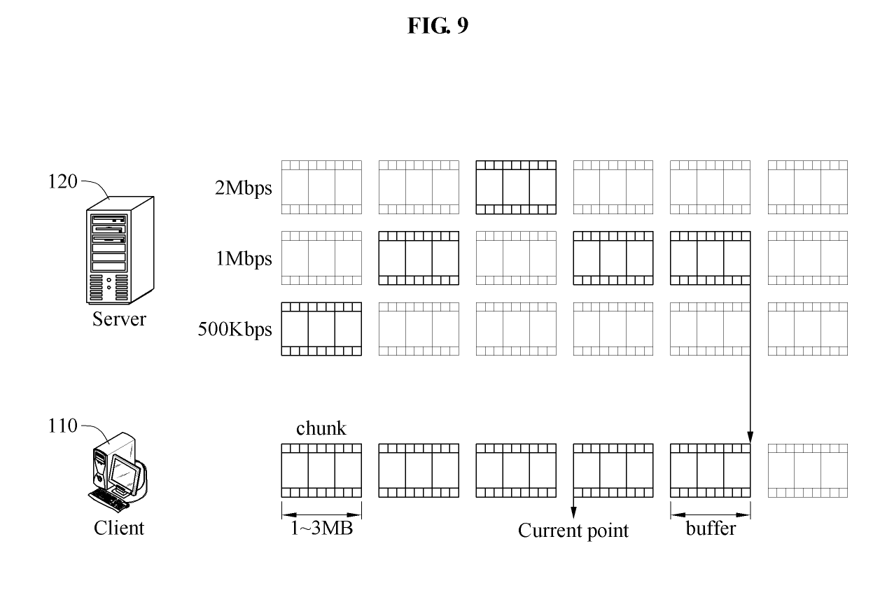

FIG. 9 illustrates an example of describing an adaptive streaming service according to an example embodiment. Referring to FIG. 9, the client 110 may receive chunks from the server 120 based on various bitrates. As described above, according to example embodiments, chunks may not be required to start with a key frame and may not include the key frame. Accordingly, the server 120 has no need to perform encoding to be suitable for a chunk, and may divide and thereby transmit a general image file, such as MP4, etc., based on a capacity unit. Since a condition of starting chunks transmitted between the server 120 and the client 110 with a key frame or including the key frame is not required, example embodiments may support open GOP as well as closed GOP.

The client 110 may download in advance chunks by a size of a buffer. The client 110 may store played back chunks and thus, may prevent duplicate downloading of corresponding chunks when playing back again frames included in the stored chunks.

The units and/or modules described herein may be implemented using hardware components, software components, or a combination thereof. a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An operating method of a client for a streaming service, the method comprising:
receiving a header of a file corresponding to a file uniform resource locator (URL) from a streaming server;
determining a first byte range based on the header;
transmitting a first request packet that includes the file URL and the first byte range to the streaming server;
receiving a first media chunk of the first byte range among media data of the file corresponding to the file URL; and
playing back the first media chunk.

2. The method of claim 1, further comprising:
receiving a seek request;
determining a second byte range based on the header and the seek request;
transmitting a second request packet that includes the file URL and the second byte range to the streaming server;
receiving a second media chunk of the second byte range among the media data of the file corresponding to the file URL; and
playing back the second media chunk.

3. The method of claim 2, wherein the determining of the second byte range comprises:
acquiring one of a random access point (RAP) of a point corresponding to the seek request and a previous RAP of a point before the point, based on the header; and
setting one of the RAP and the previous RAP as a start point of the second byte range.

4. The method of claim 1, further comprising:
receiving a resolution change request;
receiving a header of a second file having a resolution corresponding to the resolute change request from the streaming server;
determining a second byte range based on the header of the second file and a current playback point;
transmitting a second request packet that includes a file URL of the second file and the second byte range to the streaming server;
receiving a second media chunk of the second byte range among media data of the second file; and
playing back the second media chunk.

5. The method of claim 4, wherein the determining of the second byte range comprises:
acquiring a subsequent RAP of a point after the current playback point, based on the header of the second file; and
setting the subsequent RAP as a start point of the second byte range.

6. The method of claim 1, wherein the playing back of the first media chunk comprises:
creating a first header for the first media chunk based on the header; and
playing back a first chunk media file that includes the first header and the first media chunk using a first thread.

7. The method of claim 1, further comprising:
determining a second byte range based on the first byte range;
transmitting a second request packet that includes the file URL and the second byte range to the streaming server;
receiving a second media chunk of the second byte range among the media data of the file corresponding to the file URL; and
playing back the second media chunk.

8. The method of claim 7, wherein the playing back of the second media chunk comprises:
creating a second header for the second media chunk based on the header; and
playing back a second chunk media file that includes the second header and the second media chunk using a second thread.

9. The method of claim 8, wherein the playing back of the second chunk media file comprises:
detecting whether a playback start point of the second media chunk is reached;
switching a first thread used to decode the first media chunk to the second thread in response to reaching the playback start point of the second media chunk; and
decoding the second media chunk using the second thread.

10. The method of claim 7, wherein the playing back of the second media chunk comprises:
setting a 2'-nd media chunk that includes at least a portion of the first media chunk and at least a portion of the second media chunk;
creating a 2'-nd header for the 2'-nd media chunk based on the header; and
playing back a 2'-nd chunk media file that includes the 2'-nd header and the 2'-nd media chunk using a second thread.

11. The method of claim 10, wherein the setting of the 2'-nd media chunk comprises including a portion of the first media chunk in the 2'-nd media chunk based on a previous or subsequent frame range referred to by a frame encoded using an open GOP (group of pictures).

12. The method of claim 1, further comprising:
receiving a plurality of file URLs corresponding to a plurality of resolutions of the same content from the streaming server.

13. A non-transitory computer-readable recording medium storing a program to implement the method of claim 1.

14. A client device for a streaming device, comprising:
a memory configured to store a header and a file uniform resource locator (URL) of a file of a first resolution;
a processor configured to determine a first byte range based on the header; and
a communicator configured to transmit a first request packet that includes the file URL and the first byte range to the streaming server, and to receive a first media chunk of the first byte range among media data of the file of the first resolution.

15. The client device of claim 14, wherein, in response to a seek request, the processor is further configured to acquire one of a random access point (RAP) of a point corresponding to the seek request and a previous RAP of a point before the point, and to determine a second byte range that uses one of the RAP and the previous RAP as a start point, and
the communicator is further configured to transmit a second request packet that includes the file URL and the second byte range to the streaming server, and to receive a second media chunk of the second byte range among the media data of the file of the first resolution.

16. The client device of claim 14, wherein the memory is further configured to further store a header and a file URL of a file of a second resolution, and
in response to a resolution change request, the processor is further configured to acquire a subsequent RAP of a point after a current playback point based on the header of the file of the second resolution, and to determine a second byte range that uses the subsequent RAP as a start point, and
the communicator is further configured to transmit a second request packet that includes the file URL of the file of the second resolution and the second byte range to the streaming server, and to receive a second media chunk of the second byte range among the media data of the file of the second resolution.

17. The client device of claim 14, wherein the processor is further configured to determine a second byte range based on the first byte range, and
the communicator is further configured to transmit a second request packet that includes the file URL and the second byte range to the streaming server, and to receive a second media chunk of the second byte range among the media data of the file of the first resolution.
